(19) United States
(12) Patent Application Publication
(10) Pub. No.: US 2010/0285288 A1
(43) Pub. Date: Nov. 11, 2010

(54) BONDING METHOD FOR HETERO-MATERIALS AND COMPOSITE SHELL BODY MADE THEREBY

(75) Inventors: Shih-Chieh Chen, Taichung County (TW); Yung-Chih Chen, Taichung County (TW); Chun-Hsien Lee, Taichung County (TW); Tsung-Kuei Wei, Taichung County (TW); Tsung-Che Lee, Taichung County (TW); Chia-Liang Hung, Taichung County (TW)

Correspondence Address: HAMRE, SCHUMANN, MUELLER & LARSON, P.C., P.O. BOX 2902, MINNEAPOLIS, MN, 55402-0902, US

(73) Assignee: TAIWAN GREEN POINT ENTERPRISES CO., LTD., Taichung County (TW)

(21) Appl. No.: 12/776,036

(22) Filed: May 7, 2010

Related U.S. Application Data
(60) Provisional application No. 61/177,078, filed on May 11, 2009.

(30) Foreign Application Priority Data
Jan. 4, 2010 (TW) 099100017

(51) Int. Cl. B32B 3/10; B29C 45/14; B29C 35/08; C23F 1/02

(52) U.S. Cl. 428/210; 264/265; 264/400; 264/430; 216/39

(57) ABSTRACT

A bonding method for hetero-materials includes the steps of: a) preparing a ceramic substrate having opposite first and second surfaces; b) micro-structurizing the substrate to form a plurality of micro-structures and a plurality of indentations on the first surface of the substrate; c) preparing a mold including a first mold part having a mold cavity, and a second mold part; d) disposing the substrate in the mold cavity; e) closing the first mold part so that a molding space is defined between the second mold part and the first surface of the substrate; and f) insert-molding a polymeric material in the molding space so as to form a polymeric layer bonding to the first surface of the substrate by filling the polymeric material into the indentations. A composite shell body including a ceramic substrate and a polymeric layer is also disclosed.

### CROSS-REFERENCE TO RELATED APPLICATION

This application claims priority from U.S. Provisional Patent Application No. 61/177,078, filed on May 11, 2009.

### BACKGROUND OF THE INVENTION

1. Field of the Invention

The invention relates to a bonding method, and more particularly to a bonding method for hetero-materials. The invention also relates to a composite shell body made by the bonding method.

2. Description of the Related Art

A ceramic material is one having good thermal characteristics, corrosion resistance, and abrasion resistance, and thus is widely applied to electronic components, electronic devices, engines, construction elements of a chemical plant, and especially to consumer electronic products.

However, ceramic products are usually brittle, and thus are liable to crack when subjected to impact. In order to address the brittle problem and to improve the structural strength of the ceramic products, a reinforcing layer made of a polymeric material is bonded to the ceramic products so as to improve the impact resistance of the ceramic products by absorbing the stress produced when the ceramic products are subjected to impact. However, the surface of the ceramic products is usually smooth. Therefore, the bonding strength between the reinforcing layer and the ceramic products is insufficient, and the reinforcing layer is liable to be stripped from the ceramic products.

Therefore, it is desirable in the art to provide a method which can improve the bonding strength between a ceramic material and a reinforcing material heterogeneous to the ceramic material.

### SUMMARY OF THE INVENTION

An object of the present invention is to provide a bonding method for hetero-materials capable of improving the bonding strength between a ceramic material and a reinforcing material heterogeneous to the ceramic material.

Another object of the present invention is to provide a composite shell body made by the bonding method.

In one aspect of this invention, a bonding method for hetero-materials includes the steps of: a) preparing a substrate made of ceramic and having a first surface and a second surface opposite to the first surface; b) micro-structurizing the substrate to form a plurality of micro-structures and a plurality of indentations defined by the micro-structures on the first surface of the substrate; c) preparing a mold including a first mold part having a mold cavity, and a second mold part; d) disposing the substrate in the mold cavity so that the first surface of the substrate faces toward the second mold part; e) closing the first mold part by the second mold part so that a molding space is defined between the second mold part and the first surface of the substrate; and f) insert-molding a polymeric material in the molding space so as to form a polymeric layer bonding to the first surface of the substrate by filling the polymeric material into the indentations.

In another aspect of this invention, a composite shell body includes a substrate and a polymeric layer. The substrate is made of ceramic and has a first surface, a second surface opposite to the first surface, and a plurality of micro-structures and a plurality of indentations defined by the micro-structures on the first surface. The polymeric layer has a plurality of protrusions and bonds to the first surface of the substrate by filling the indentations with the protrusions correspondingly.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a flow chart of a first preferred embodiment of a bonding method for hetero-materials according to the present invention;

FIG. 2 is a fragmentary schematic view of a ceramic substrate produced during the first preferred embodiment;

FIG. 3 is a schematic view of a mold used in the first preferred embodiment;

FIG. 4 is a fragmentary schematic sectional view of a composite shell body made by the first preferred embodiment;

FIG. 5 is a fragmentary schematic sectional view of another example of the composite shell body made by the first preferred embodiment;

FIG. 6 is a fragmentary schematic sectional view of yet another example of the composite shell body made by the first preferred embodiment;

FIG. 7 is a flow chart of a second preferred embodiment of a bonding method for hetero-materials according to the present invention;

FIG. 8 is a schematic sectional view of a mold used in the second preferred embodiment; and

FIG. 9 is a fragmentary sectional view of a composite shell body made by the second preferred embodiment.

### DETAILED DESCRIPTION OF THE PREFERRED EMBODIMENTS

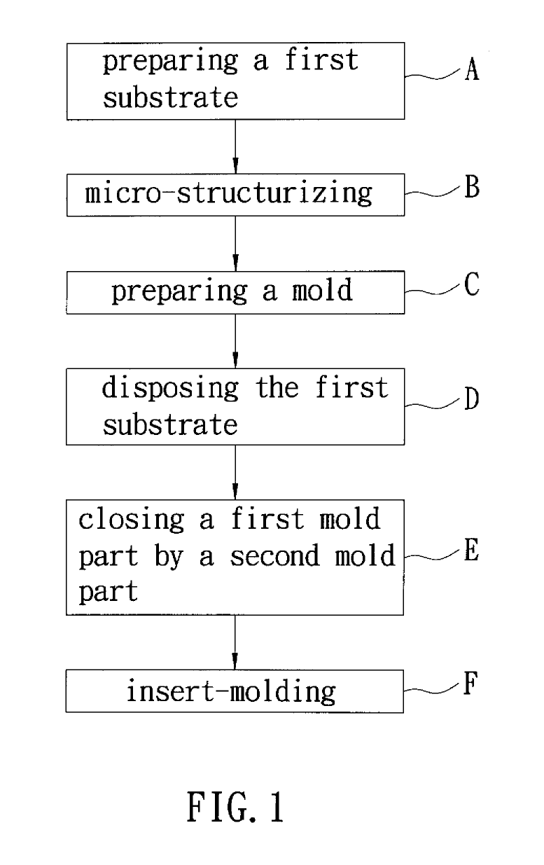

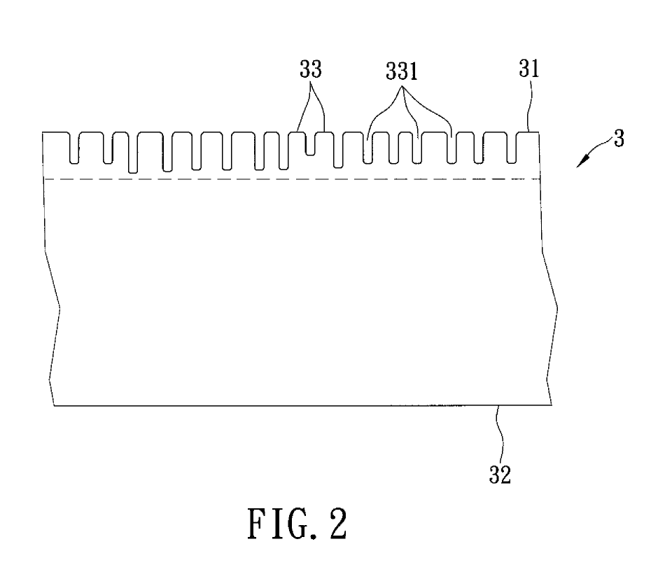

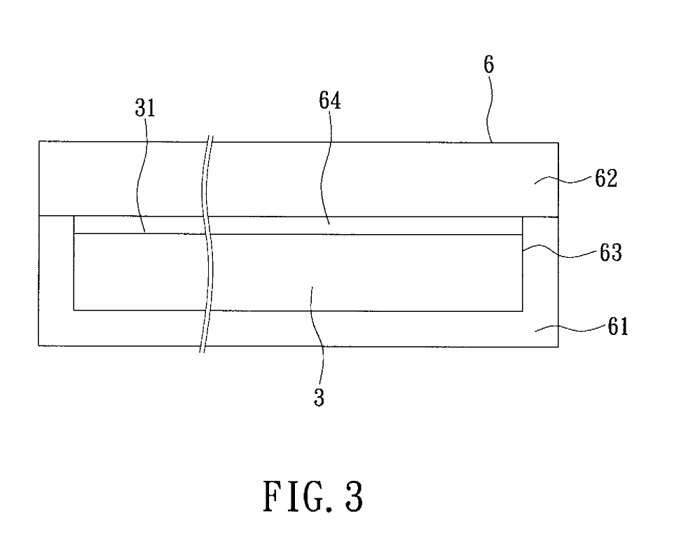

Referring to FIGS. 1, 2, 3, and 4, the first preferred embodiment of a bonding method for hetero-materials according to the present invention includes the steps of:

A) preparing a first substrate:

A first substrate 3 is prepared, which is made of ceramic and which has a first surface 31, a second surface 32 opposite to the first surface 31, and a peripheral surface 34 extending between the first and second surfaces 31, 32.

B) micro-structurizing:

The first substrate 3 is micro-structurized to form a plurality of micro-structures 33 and a plurality of indentations 331 defined by the micro-structures 33 on the first surface 31 of the first substrate 3. Preferably, the micro-structures 33 have a mean height equal to or smaller than half of a thickness of the first substrate 3 so as to provide the first substrate 3 with good structural strength. Preferably, the thickness of the first substrate 3 is greater than 0.3 mm.

The micro-structurizing step can be conducted by electrical discharge machining, sand blasting, mechanical machining, ultrasonic machining, laser beam machining, chemical hydrolyzing, or the like.

Regarding the sand blasting, a photo-resistant layer is formed on the first surface 31 of the first substrate 3. A mask having a predetermined pattern is then formed on the first surface 31 of the first substrate 3 by removing parts of the photo-resistant layer via lithography. The area of the first surface 31 which is not covered by the mask is processed using a sand blasting material made of silicon carbide (SiC) or alumina (Ai₂O₃), and the mask is then removed so as to obtain a plurality of the microstructures 33 on the first surface of the first substrate 3. The distribution of the micro-structures 33 can be designed according to the pattern of the mask.

Regarding the mechanical machining, the indentations 331 can be formed using a drilling bit that rotates at a drilling speed of greater than 70,000 rpm. A specific shape and/or size of the indentations 331 can be obtained using a specific drilling bit. Preferably, the diameter of the drilling bit suitable for forming the indentations 331 ranges from 20 μm to 200 μm so as to form the indentations 331 having a mean size ranging from 20 μm to 200 μm.

Regarding the laser beam machining, the first surface 31 of the first substrate 3 is processed using a laser beam of greater than 15 W to form the micro-structures 33 and the indentations 331 on the first surface 31 of the first substrate 3.

Regarding the electrical discharge machining, the first surface 31 of the first substrate 3 is coated with an electrically conductive layer, and is then processed using the electrical discharge machining so as to form the micro-structures 33 and the indentations 331 thereon. A specific shape and/or size of the indentations 331 can be obtained using a specific design of an electrode and a specific control of electric current. Preferably, the indentations 331 formed by the electrical discharge machining have a mean size ranging from 20 μm to 200 μm.

Regarding the chemical hydrolyzing, the first surface 31 of the first substrate 3 is immersed in a hydrolyzing solution so as to form the micro-structures 33 and the indentations 331 thereon. A specific shape and/or size of the indentations 331 can be obtained by controlling the pH value of the hydrolyzing solution. Preferably, the indentations 331 formed by the chemical hydrolyzing have a mean size ranging from 20 μm to 200 μm.

C) preparing a mold:

A mold 6 is prepared, which includes a first mold part 61 having a first mold cavity 63, and a second mold part 62.

D) disposing the first substrate:

The first substrate 3 is disposed in the first mold cavity 63 so that the first surface 31 of the first substrate 3 faces toward the second mold part 62.

E) closing the first mold part by the second mold part:

The first mold part 61 is closed by the second mold part 62 so that a molding space 64 is defined between the second mold part 62 and the first surface 31 of the first substrate 3.

F) insert-molding:

A polymeric material is insert-molded in the molding space 64 so as to form a polymeric layer 4 bonding to the first surface 31 of the first substrate 3 by filling the polymeric material into the indentations 331.

The polymeric material can be thermoplastic or thermosetting. The molten polymeric material is charged into the molding space 64 to completely cover the first surface 31 of the first substrate 3 and to fill the indentations 331. The polymeric layer is formed and bonds to the first surface 31 of the first substrate 3 after cooling the polymeric material.

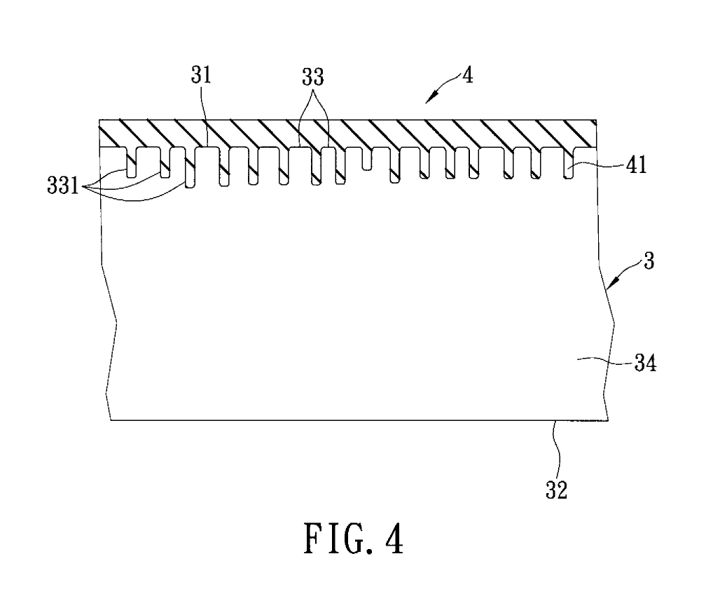

Specifically referring to FIG. 4, a composite shell body made the first preferred embodiment of a bonding method for hetero-materials according to the present invention includes a substrate 3 and a polymeric layer 4.

The substrate 3 is made of ceramic, and has a first surface 31, a second surface 32 opposite to the first surface 31, and a plurality of micro-structures 33 and a plurality of indentations 331 defined by the micro-structures 33 on the first surface 31. As described above, preferably, the thickness of the substrate 3 is greater than 0.3 mm. More preferably, the thickness of the substrate 3 is greater than 0.3 mm and less than 3 mm in view of manufacturing capability. Most preferably, the thickness of the substrate 3 ranges from 0.4 mm to 0.6 mm. Specifically, the maximum thickness of the substrate 3 is preferably 1.5 mm for a portable product. The micro-structures 33 have a mean height equal to or smaller than half of a thickness of the substrate 3. For example, when the thickness of the substrate 3 is 1.5 mm, the mean height of the micro-structures 33 is equal to or smaller than 0.75 mm.

The polymeric layer 4 is formed by insert-molding of a polymeric material, has a plurality of protrusions 41, and bonds to the first surface 31 of the first substrate 3 by filling the indentations 331 with the protrusions 41 correspondingly.

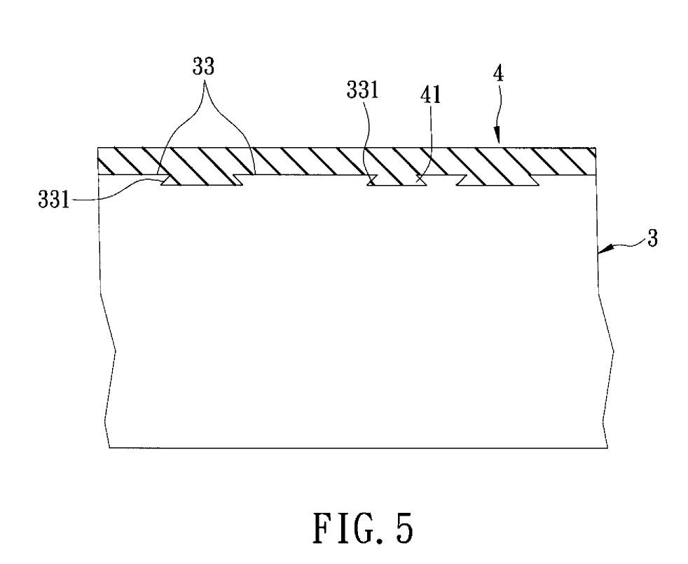

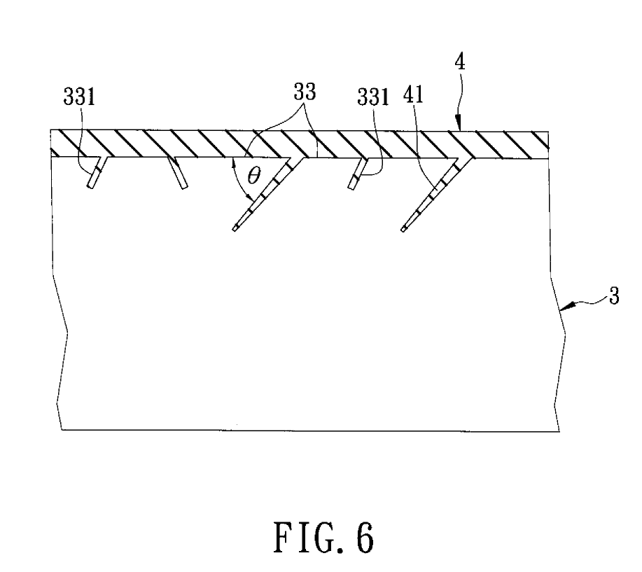

Referring to FIGS. 5 and 6, the indentations 331 can have different configurations. For example, each of the indentations 331 can have a restricted opening, as best shown in FIG. 5, or can be inclined, as shown in FIG. 6. When the indentations 331 are inclined, they are preferably inclined at an angle (θ) ranging from 30° to 60°.

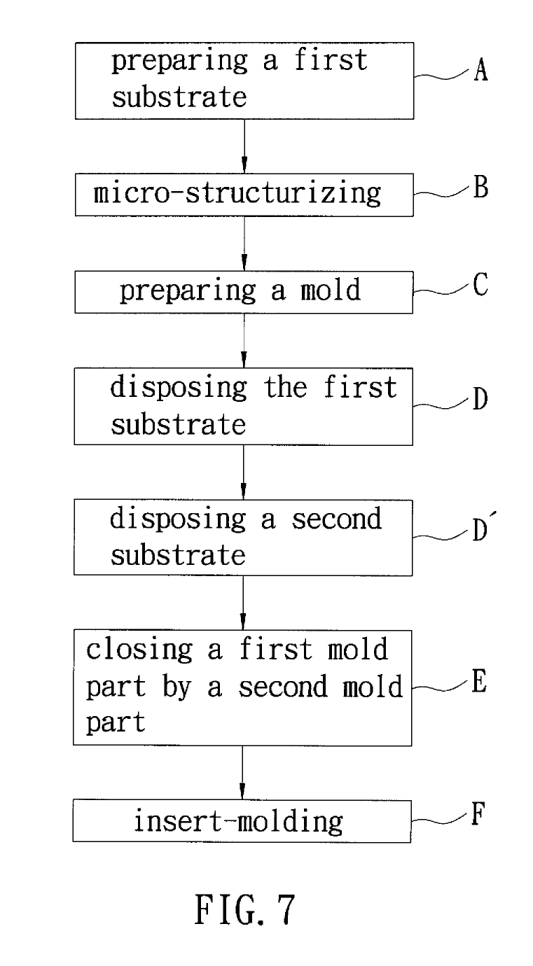

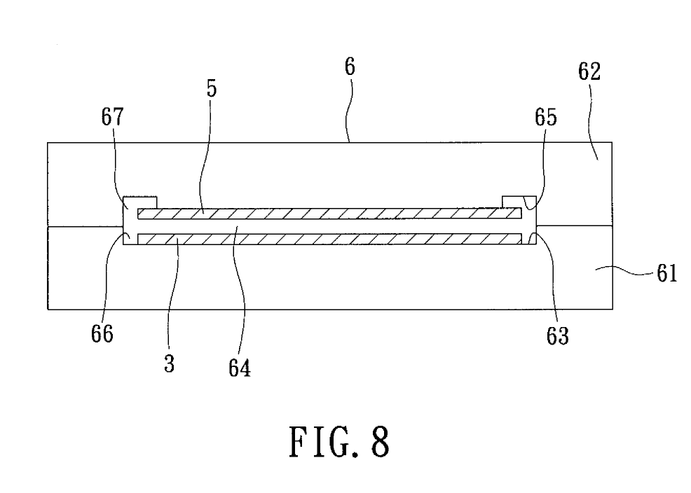

Referring to FIGS. 7, 8 and 9, the second preferred embodiment of a bonding method for hetero-materials according to the present invention is similar to the first preferred embodiment except for the following:

In the second preferred embodiment, a plurality of the micro-structures 33 and a plurality of the indentations 331 are additionally formed on the peripheral surface 34 of the first substrate 3 in step B), i.e., the micro-structurizing step.

The second mold part 62 has a second mold cavity 65, and the second preferred embodiment of the bonding method according to the present invention further includes a step D′) of disposing a second substrate 5 in the second mold cavity 65 so that the first molding space 64 is formed between the first and second substrates 3, 5, a second molding space 66 is formed between the first mold part 61 and the first substrate 3, and a third molding space 67 is formed between the second mold part 62 and the second substrate 5 after the first mold part 61 is closed by the second mold part 62 and so that the first, second, and third molding spaces 64, 66, 67 are in fluid communication with each other. The second substrate 5 may be made of a material identical to or different from that of the first substrate 3, and may be metal, ceramic, or plastic.

In step F), the polymeric material is insert-molded in the first, second, and third molding spaces 64, 66, 67 so that the polymeric layer 4 is formed between the first and second substrates 3, 5, bonds to the first and peripheral surfaces 31, 34 of the first substrate 3 by filling the polymeric material into the indentations 331, and encloses and connects to the second substrate 5.

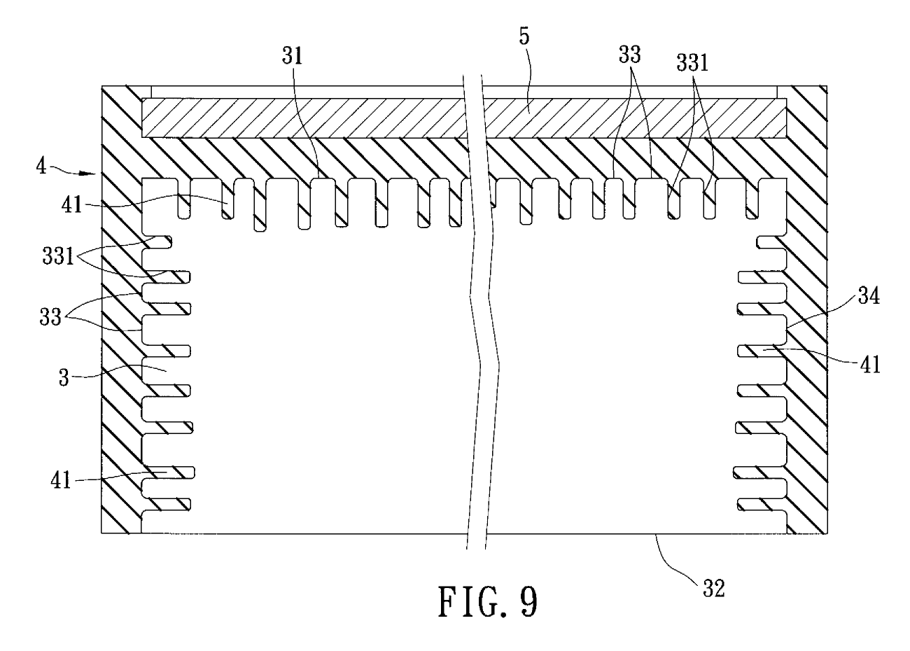

Specifically referring to FIG. 9, a composite shell body made by the second preferred embodiment of a bonding method for hetero-materials according to the present invention is similar to the composite shell body made by first preferred embodiment except for the following:

The composite shell body made by the second preferred embodiment further includes the second substrate 5 enclosed by and connected to the polymeric layer 4 and disposed opposite to the first substrate 3. The peripheral surface 34 of the first substrate 3 is formed with the micro-structures 33 and the indentations 331. The polymeric layer 4 further bonds to the peripheral surface 34 of the first substrate 3 by filling the indentations 331 of the peripheral surface 34 with the protrusions 41 correspondingly.

Since the micro-structures 33 and the indentations 331 are formed on the first surface 31 and/or the peripheral surface 34 of the first substrate 3, the polymeric layer formed by insert-molding can bond to the first surface 31 and/or the peripheral surface 34 of the first substrate 3 firmly so as to enhance the bonding strength between the polymeric layer 4 and the first substrate 3 made of ceramic. The stripping problem encountered in the prior art can be alleviated.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

We claim:

1. A bonding method for hetero-materials, comprising the steps of:
a) preparing a first substrate made of ceramic and having a first surface and a second surface opposite to the first surface;
b) micro-structurizing the first substrate to form a plurality of micro-structures and a plurality of indentations defined by the micro-structures on the first surface of the first substrate;
c) preparing a mold including a first mold part having a first mold cavity, and a second mold part;
d) disposing the first substrate in the first mold cavity so that the first surface of the first substrate faces toward the second mold part;
e) closing the first mold part by the second mold part so that a first molding space is defined between the second mold part and the first surface of the first substrate; and
f) insert-molding a polymeric material in the first molding space so as to form a polymeric layer bonding to the first surface of the first substrate by filling the polymeric material into the indentations.

2. The bonding method as claimed in claim 1, wherein the micro-structures have a mean height equal to or smaller than half of a thickness of the first substrate.

3. The bonding method as claimed in claim 2, wherein the thickness of the first substrate is greater than 0.3 mm.

4. The bonding method as claimed in claim 1, wherein step b) is conducted by a procedure selected from the group consisting of electrical discharge machining, sand blasting, mechanical machining, ultrasonic machining, laser beam machining, and chemical hydrolyzing.

5. The bonding method as claimed in claim 1, wherein the first substrate further has a peripheral surface extending between the first and second surfaces, a plurality of the micro-structures and a plurality of the indentations being additionally formed on the peripheral surface of the first substrate in step b).

6. The bonding method as claimed in claim 5, wherein the second mold part has a second mold cavity, the bonding method further comprising a step of disposing a second substrate in the second mold cavity so that the first molding space is formed between the first and second substrates, a second molding space is formed between the first mold part and the first substrate, and a third molding space is formed between the second mold part and the second substrate after the first mold part is closed by the second mold part and so that the first, second, and third molding spaces are in fluid communication with each other, the polymeric material being insert-molded in the first, second, and third molding spaces so that the polymeric layer is formed between the first and second substrates, bonds to the first and peripheral surfaces of the first substrate by filling the polymeric material into the indentations, and encloses and connects to the second substrate after the insert-molding.

7. A composite shell body comprising:
a first substrate made of ceramic and having a first surface, a second surface opposite to said first surface, and a plurality of micro-structures and a plurality of indentations defined by said micro-structures on said first surface; and
a polymeric layer having a plurality of protrusions and bonding to said first surface of said first substrate by filling said indentations with said protrusions correspondingly.

8. The composite shell body as claimed in claim 7, wherein said micro-structures have a mean height equal to or smaller than half of a thickness of said first substrate.

9. The composite shell body as claimed in claim 8, wherein said thickness of said first substrate is greater than 0.3 mm.

10. The composite shell body as claimed in claim 7, wherein said first substrate further has a peripheral surface extending between said first and second surfaces and formed with said micro-structures and said indentations.

11. The composite shell body as claimed in claim 10, wherein said polymeric layer further bonds to said peripheral surface of the first substrate by filling said indentations of said peripheral surface with said protrusions correspondingly.

12. The composite shell body as claimed in claim 10, further comprising a second substrate enclosed by and connected to said polymeric layer and disposed opposite to said first substrate.

13. The composite shell body as claimed in claim 7, wherein each of said indentations has a restricted opening.

14. The composite shell body as claimed in claim 7, wherein each of said indentations is inclined at an angle ranging from 30° to 60°.
